(19) United States
(12) Patent Application Publication
(10) Pub. No.: US 2020/0272871 A1
(43) Pub. Date: Aug. 27, 2020

(54) BLENDING PIXEL CELLS

(71) Applicant: Hewlett-Packard Development Company, L.P., Spring, TX (US)

(72) Inventors: Bryan Crampton, Corvallis, OR (US); Thomas J. Gilg, Corvallis, OR (US); Mahesh Balakrishnan, Corvallis, OR (US); Balaram Sahu, Corvallis, OR (US); Prasanth Gopinathan, Corvallis, OR (US)

(73) Assignee: Hewlett-Packard Development Company, L.P., Spring, TX (US)

(21) Appl. No.: 16/632,559

(22) PCT Filed: Nov. 20, 2017
(86) PCT No.: PCT/US2017/062463

§ 371 Date: Jan. 21, 2020

(51) Int. Cl. G06K 15/02

(52) U.S. Cl. CPC G06K 15/1889; G06K 15/1878; G06K 15/1886; G06K 15/1836

(57) ABSTRACT

A method includes receiving compressed data representing a page of a document that is associated with a plurality of cell lines. A given cell line of the plurality of cell lines includes a given cell, and the given cell is associated with a plurality of intersecting objects. The technique includes blending a first cell associated with a first object of the plurality of objects with a second cell that is associated with at least one other object of the plurality of objects to provide printer raster image data for the given cell. The blending includes determining whether the first and second cells are both edge cells; and in response to determining that the first and second cells are both edge cells, decompressing the compressed data corresponding to the first and second cells to provide decompressed data, and blending the first and second cells based on the decompressed data.

### BACKGROUND

For purposes of printing a document on a digital printing press, a document description file (a portable document file (PDF), for example) may be processed to generate raster image data for the press. The raster image data represents raster images for pages of the document. A raster image is a bit map, which defines a grid of pixels or pixel cells of a document page and defines colors or continuous tones for the pixels/pixel cells.

### BRIEF DESCRIPTION OF THE DRAWINGS

FIG. 1 is a schematic diagram of a system that includes a digital printing press according to an example implementation.

FIG. 2A is an illustration of a cell line table generated and used by a recomposition engine of the system of FIG. 1 according to an example implementation.

FIG. 2B depicts an example target cell line according to an example implementation.

FIGS. 3 and 6 are illustrations of cell blending according to example implementations.

FIG. 4 is an illustration of an object intersection table generated and used by the recomposition engine of FIG. 1 according to an example implementation.

FIG. 5 is a flow diagram depicting a technique to generate raster image data according to an example implementation.

FIG. 7A is an illustration of the blending of an edge cell and a solid color cell according to an example implementation.

FIG. 7B is an illustration of the blending of edge cells according to an example implementation.

FIG. 7C is an illustration of the reduction of the number of colors of the blended cell of FIG. 7C to produce a blended cell having a reduced number of colors according to an example implementation.

FIG. 7D is an illustration of the blending of edge cells to produce a single color cell according to an example implementation.

FIG. 8 is an illustration of source cell blending according to an example implementation.

FIG. 9 is a flow diagram depicting a technique to blend pixel cells according to an example implementation.

FIG. 10 is an illustration of machine executable instructions to blend pixel cells according to example implementations.

FIG. 11 is a schematic diagram of an apparatus to blend pixel cells according to an example implementation.

### DETAILED DESCRIPTION

Variable Data Printing (VDP) printing refers to a form of digital printing in which some variable objects, such as texts, graphics and images, may change from one printing of a document to the next; and other, reoccurring, or static, objects of the document do not change. As examples, VDP printing may be used for purposes of printing brochures, advertisements, announcements, and so forth, with information (mailing addresses, for example) that changes among the copies that are produced by the printing press. VDP may present challenges for print shops and their content creators due the changing content.

In general, to print a VDP document, a print server may analyze a document file that describes the VDP document, such as a portable document format (PDF) file to analyze the document file to identify the static and variable objects of the document. Once identified, the static objects may be processed to derive the corresponding raster image data, and the raster image data for the static objects may then be reused until no longer needed. Through the reuse of the raster image data for static image objects, computing intensive operations that may otherwise be used to produce raster images for the reoccurring static may be reduced.

The printer server may include a raster image processor that generates the raster image data for the pages of a document to be printed. One way for the raster image processor to generate the raster image data for a given document page is for the processor to allocate a region of memory for the entire page and use the memory region as a canvas. For this technique, for each object of the document page, the raster image data may write data to the region of memory to effectively form the object on the canvas and blend the object with any other objects that partially or wholly share the same space on the canvas.

Processing a given document page to generate raster data may, however, may be relatively inefficient, however, as such operations may consume a significant amount of memory and may be associated with relatively intensive computing operations. In accordance with example implementations that are described herein, a raster image processor, or recomposition engine, generates raster image data for a document page for one pixel cell row, or line, at a time; communicates the raster image data to a digital printing press; and then repeats the process until raster data for all of the pixel lines are communicated to the digital printing press. Generating raster image data in this manner reduces the load on memory and computing resources, as further described herein.

In the context of this application, a “pixel cell,” or “cell” is associated with an atomic spatial unit of an image, such as a raster image of a document page. For example, the raster image of the document page may be viewed as being formed from a rectangular grid of pixel cells. As an example, in accordance with some implementations, a “cell” may be associated with a single pixel may be associated with a particular color value. As another example, in accordance with some implementations, a “cell” may be a collection, or group, of spatially adjacent pixels, and the pixels of the cell may be associated with the same color. For example, the cell may be a block of 4×4 pixels that is associated with a particular color (i.e., the color is homogenous for the cell).

In accordance with example implementations, a given pixel cell may be a solid color cell, i.e., a pixel cell in which all pixel(s) of the have the same color. Moreover, in accordance with example implementations, a solid color cell may be by definition opaque, meaning that the solid color pixel cell dominates any pixel cells that are disposed beneath the solid color pixel cell.

A given pixel cell may be a block of pixels that form an “edge cell.” In general, an edge is a multiple pixel, pixel cell (a 4×4 block of pixel cells or other size, as examples) that has more than one color. In accordance with some implementations, one or multiple pixel cells of an edge cell may have some degree of transparency. In this manner, in accordance with some implementations, a pixel of a pixel cell may have a “shading,” or transparency level, which defines the degree of transparency (or opacity) of the cell. The pixel cell may have an associated “color shading,” which refers to a combination of a color and a degree of transparency for the cell.

In accordance with some implementations, a pixel may have two levels of shading: a first level (L1); and a second level (L2). In this manner, the L2 level may be relatively more opaque that the first level L1, so that when an L1 pixel cell is disposed beneath an L2 pixel cell, the L2 pixel cell dominates.

The edge cell may be a continuous tone cell, in accordance with some implementations, such as, for example, an Indigo compressed format (ICF) continuous tone, or “contone.”

In general, the image of an object may be partitioned into pixel cells called “object source cells,” or “source cells.” The raster image of a document page may be partitioned into pixel cells called “target cells.” Moreover, a document page may be associated with “cell lines,” which may be viewed as the raster image of the document page being horizontally partitioned into rows. In accordance with example implementations, a cell line extends across the width of the raster image, and the cell line has a height of one cell. As such, in accordance with example implementations, the number of cell lines is equal to the height of the raster image in pixels divided by the pixel height of the pixel cell, and the number of cells per cell line is equal to the width of the raster image in pixels divided by the pixel width of the pixel cell.

In general, the objects (text or graphics, which are defined by a PDF file, for example) that are part of a given document page may be associated with different layers. The “layer” associated with an object refers to a plane in which the object lies and which is parallel to the document page. The layer number, or order, represents a depth dimension, or order, of the layer, and in accordance with example implementations, the layer number increases with distance from the plane in which the background of the document page lies.

Objects of a document page may partially or entirely intersect, or overlap; and whether or not object portions that are overlapped are visible in the raster image of the document page depends on the degrees of transparency (or opaqueness) of the overlapping pixel cells or pixels within the pixel cells (when edge cells are involved). For example, for a given document page, a pixel cell A of object A that is associated with layer number 3 may overlap a pixel cell B of object B that is associated with layer number 2. For this example, object B is located behind object A, and the pixel B may or may not be visible, depending on the degree of opaqueness of the pixel cell A. In this manner, in accordance with example implementations, a given pixel cell may be opaque, nearly opaque, nearly transparent or transparent. In accordance with example implementations, an opaque or nearly opaque pixel cell means that the cell blocks enough light to prevent the viewing of a pixel cell that is disposed at the same position and associated with a lower order layer. Moreover, in accordance with example implementations, a transparent pixel cell means that an underlying pixel cell is fully viewable; and a nearly transparent pixel cell means that values (contones or colors, depending on the particular implementation) for the cell and an underlying cell are combined, or blended. The process of determining a pixel cell value for overlapping, or intersecting, pixel cells is called “blending” herein.

As an example of the blending, for the example of pixel cell A (the layer 3 pixel cell) and pixel cell B (the layer 2 pixel cell) given above, if pixel cell A is a solid color pixel cell, then pixel cell B may not be visible (such as in implementations in which a solid color pixel is opaque by definition). If pixel cells A and B are both solid color pixel cells, then pixel cell B is not visible due to pixel cell A being the upper cell. If pixel cell B is a solid color pixel cell and pixel cell A is an edge cell, then pixel cell A may not be visible (such as in implementations in which a solid color pixel is opaque and dominates by definition). If pixel cells A and B are both edge cells, then parts of both pixel cells A and B may be visible, depending on the relative degrees of transparency, or shading, as further described herein.

In accordance with example implementations, the recomposition engine processes a document description file for purposes of generating a cell line table, which identifies, for each cell line associated with the document page, which objects are associated with the cell line. In other words, for each cell line, the cell line table identifies objects that are partially or fully contained in the cell line and the positions of the contained objects.

The recomposition engine, in accordance with example implementations, constructs an object intersection table from the cell line table for purposes of identifying intersections of objects (if any) for each cell line. Using the object intersection table, the recomposition engine may then process the cell lines (called “target cell lines” herein) one at a time and communicate raster image data to the digital printing press in corresponding units of data. In this manner, in accordance with example implementations, the recomposition engine may, for a given target cell line, determine whether objects overlap, or intersect, in the given target cell line, and based on a result of this determination, perform a blending of the intersecting source object cells (if any) for purposes of generating the raster image data for the target cell line. Moreover, as described herein, in accordance with example implementations, the recomposition engine may use the cell line intersection table to, for a given target cell line, optimize the generation of raster image data for the target cell line to accommodate the cases in which one or no objects are contained in the cell line or the case in which multiple objects exist for the cell line but do not intersect.

As described further herein, in accordance with example implementations, the recomposition engine may blend pixel cells for overlapping objects in a manner that conserves memory and computing resources. More specifically, in accordance with example implementations, the recomposition engine may, in general, blend pixel cells that are not edge cells in a compressed domain, in that the blending may process compressed data representing overlapping pixel cells to blend these pixel cells and produce corresponding raster image data without decompressing the data. In accordance with example implementations, the recomposition engine may determine if a pair of pixel cells to be blended are edge pixel cells, and if so, the recom position engine may first decompress the corresponding data representing these cells and then perform the blending using decompressed data, as further described herein.

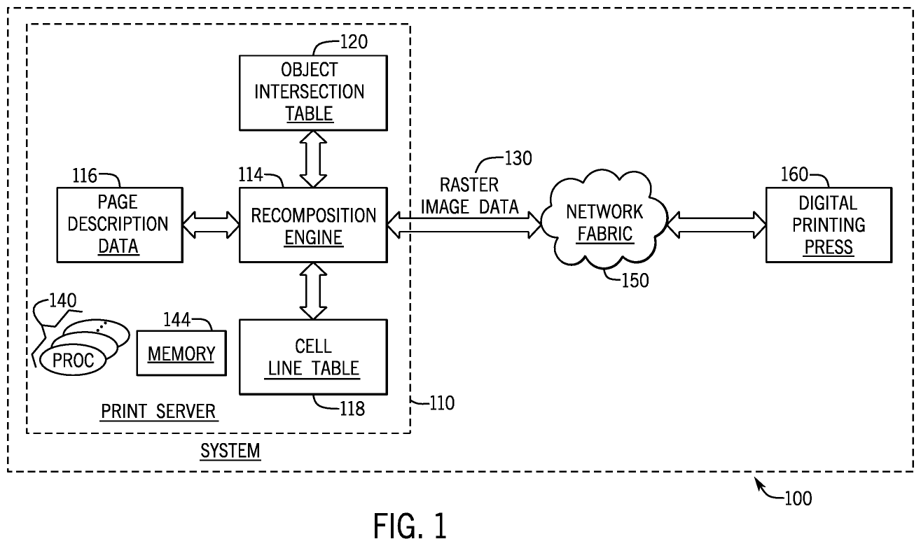

As a more specific example, FIG. 1 depicts a system 100 in accordance with some implementations. In general, the system 100 includes a recomposition engine 114 that receives page description data 116, which indicates, or represents, a description of one or multiple pages of a document to be printed. As an example, in accordance with some implementations, the page description data 116 may be data contained in a portable document file (PDF), which may describe one or multiple document pages to be printed. Moreover, in accordance with some implementations, the page description data 116 may describe static objects and variable objects associated with VDP. Regardless of its particular form, the page description data 116 describes a document page containing one or multiple objects, which the recomposition engine 114 processes to produce raster image data 130 for a digital printing press 160.

In accordance with example implementations, the raster image data 130 represents a single target cell line, of a document page. As described herein, the recomposition engine 114 constructs a cell line table 118 based on the page description data 116. The cell line table 118 identifies, per cell line, which object are objects are partially or entirely contained in the cell line. Based on the cell line table 118, the recomposition engine 114 generates an object intersection table 120, which, per cell line, identifies the positions of any object(s) contained in the cell line and whether objects overlap in the cell line. Based on the object intersection table 120, the recomposition engine 114 may then, generate the raster data 130 for each target cell line, as described herein.

Among the other features of the system 100, in accordance with some implementations, the print server 110 may include one or multiple processors 140 (one or multiple central processing units (CPUs), one or multiple processing cores, and so forth) and a memory 144. In general, the memory 144 is a non-transitory memory that may store data representing machine executable instructions (or software), which are executed by one or multiple processors 140 for purposes of performing techniques that are described herein. For example, in accordance with some implementations, the memory 144 may store machine executable instructions that when executed by the processor(s) 140 may cause the processor(s) 140 to perform functions of the recomposition engine 114 as described herein. The memory 144 may further store data representing initial, intermediate and final versions of the raster image data 130, as well as other data, in accordance with example implementations.

In accordance with some implementations, the memory 144 may be formed from semiconductor storage devices, memristors, phase change memory devices, non-volatile memory devices, volatile memory devices, a combination of one or more of the foregoing memory storage technologies and so forth.

In accordance with some implementations, the recomposition engine 114 may be partially or wholly based in software (i.e., formed by one or more of the processors 140, executing machine executable instructions). However, in accordance with further example implementations, the recomposition engine 114 may be formed partially or in whole from one or multiple hardware circuits such as one or multiple field programmable gate arrays (FPGAs) or application specific integrated circuits (ASICs).

As depicted in FIG. 1, in accordance with some implementations, the raster image data 130 may be communicated to the digital printing press 160 over network fabric 150. In accordance with example implementations, the network fabric 150 may be formed from components and use protocols that are associated with any type of communication network such as (as examples) Fiber Channel Networks, iSCSI networks, ATA over Ethernet (AoE) networks, HyperSCSI networks, local area networks (LANs), wide area networks (WANs), global networks (the Internet, for example), or any combination thereof.

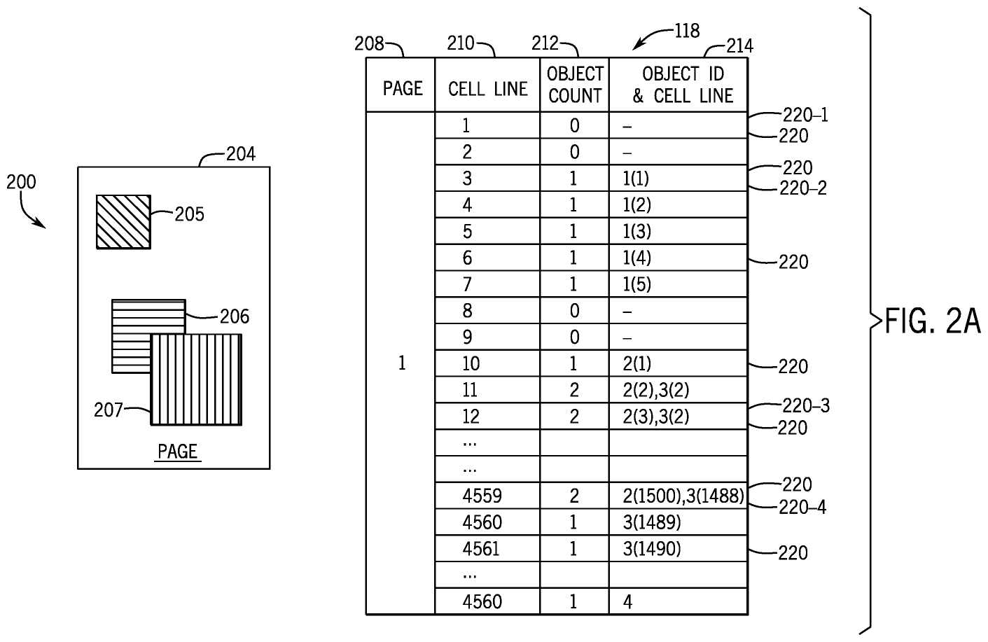

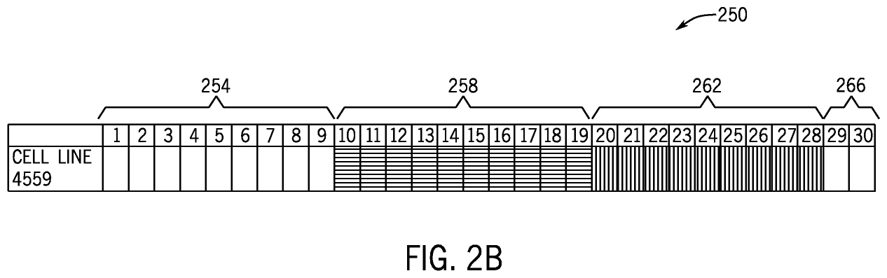

FIG. 2A is an illustration 200 depicting an example cell line table 118 that is generated by the recomposition engine 114 (FIG. 1) from an example page 204 of a document to be printed. The document page 204 contains, for this example, three objects 205, 206 and 207. Moreover, the object 206 is associated with a lower layer than the object 207, and the object 207, where the objects 206 and 207 overlap, is opaque or partially opaque (i.e., the portion of the object 206 where the objects 206 and 207 overlap cannot be seen).

The corresponding cell line table 118 may contain rows 220, where each row 220 describes the object or objects that may be contained in a cell line that is associated with the row 220. In this manner, in accordance with example implementations, the cell line table 118 includes a column 208, which identifies the particular target page 204. The cell line table 118 includes a column 210 identifying the cell lines associated with the target page 204. The number of cell lines may be equal or less than the number of vertical pixels on the page, depending on the cell size. For example, if the page 204 contains 8000 pixels in height and the compression ratio is 4:1 (i.e., 4 associated pixels per cell), then there are 2000 cell lines and 2000 corresponding rows 220 of the table 118. Each cell line, in turn, may contain, or hold, zero, one or more objects. For example, the row 220-1 corresponds to example cell line number one, and example cell line 220-4 contains information for cell line number 4559.

In accordance with example implementations, the table 118 further includes a column 212 identifying an object count for the number of implicated objects in the target cell line. For the example page 204, the object 205 does not coincide with any other object. Therefore, for the example cell line table 118, the object 205 is represented in the table 118 (as Object ID=1) with corresponding rows 220 having an object count of “1.” To the contrary, the objects 206 and 207 (represented by Object ID=2 and Object ID=3, respectively overlap, and correspondingly, rows 220 of the cell line table 118 have an object count of “2” where the objects 206 and 206 overlap. As more specific examples, row 220-1 of the cell line table 118 contains an object count of “0” representing that no objects are contained in the first cell line of the page 204. As another example, row 220-3 of the table 118, is associated with cell line number 12, contains the objects 206 and 207, and has an object count of “2.”

In accordance with example implementations, the cell line table 118 includes an object identification and cell line column 214, which contains an identifier for each object that is associated with the cell line and the particular cell line number of the object. For example, row 220-3 of the cell line table 118, which corresponds to cell line number 12, has the following entries: “2(3),” which identifies object number “2” (the object 206), and the “(3)” represents that the cell line number 12 contains row number three of the object 206; and the column 214 entry for the row 220-3 further represents that cell line number 12 contains object number 3 (i.e., the object 210) and contains cell line number two for the object.

FIG. 2B depicts an example target cell line 250 in its final state, accordance with example implementations. In particular, the target cell line 250 corresponds to row line 220-4 of the cell line table 118 and thus, corresponds to the intersection of objects 206 and 207 in cell line number 4559. The target cell line 250 contains a group 254 of cells in cell positions numbers 1 to 9, which contain background fill color as there are no objects for these cells. Due to the grouping of contiguous cells that have the same cell value, in accordance with example implementations, the group of cells 254 may be represented in the raster data 130 (FIG. 1) by compressed data, such as, for example, data that represents run length encoding or Indigo compression format (ICF) encoding, as examples. The target cell line 250 for the example of FIG. 2B also contains cells 258 in cell positions 10 to 19, which correspond to the intersection of the objects 206 and 207in cell line number 4559. The cells 258, which have the same associated values, may also be encoded, or compressed. The target cell line 250 further includes a group of cells 262 in cell positions 20 to 28, which corresponds to the object 207, where the objects 206 and 207 do not overlap. In a similar manner, due to the cells 262 corresponding to the same value, the cells 262 may be compressed, or encoded. Finally, for example target cell line 250, the cell line 250 contains another group 266 of cells in positions 29 and 30, which are associated with the background color, or no fill.

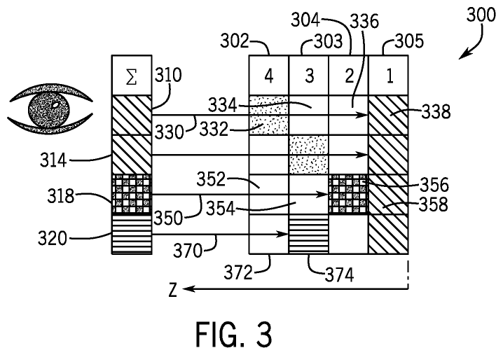

In accordance with example implementations, the recomposition engine 114 (FIG. 1) blends overlapping object source cells using reverse z-order blending, where “z” represents the page depth dimension. In particular, FIG. 3 is an illustration 300 of z-order blending for three target cells 310, 314, 318 and 320, in accordance with example implementations. Moreover, FIG. 3 depicts source cells associated with four non-background layers 302, 303, 304 and 305. In particular, for this example, the layer 305 is the lowermost layer (i.e., layer number 1), the layer 304 is the next highest layer (i.e., layer number 2), the layer 303 is the third highest layer (i.e., layer number 3), and the layer 302 is the uppermost layer (i.e., layer number 4). The reverse z-order blending, as its name implies, proceeds in a direction opposite to the z axis (i.e., proceeds in a direction into the page).

The recomposition engine 114 performs the reverse z-order blending by beginning with the uppermost layer 302 and stopping when an opaque or nearly opaque source cell is encountered. For example, for the target cell 310, the reverse z-order blending views the cells along a reverse z direction 330. In this direction, the blending first encounters a nearly transparent source cell 332 that is associated with the uppermost layer 302. Because the source cell 332 is neither nearly opaque nor opaque, the processing continues along the direction 330, and as shown, source cells 334 and 336, which are associated with the next two layers 303 and 304 are transparent. Therefore, processing along the direction 330 continues to the lowest layer source cell 338, which, for this example, is opaque or nearly opaque. Accordingly, the recomposition engine 114 assigns the value of the source cell 338 to the target cell 310.

The value for the target cell 318 is derived by processing in a reverse z-order direction, as indicated at reference numeral 350. As shown, source cells 352 and 354, which are associated with the uppermost 302 and next uppermost 303 layers, are transparent. However, a source cell 356 of the next layer 304 is opaque or nearly opaque. Therefore, the reverse z-order processing stops at the second layer 304, as the value of the source cell 356 sets the value for the target cell 318. It is noted that the reverse z-order processing ends at the layer 304, as due to the opacity of the source cell 356, the values of any source cells below the cell 356 do not contribute to or affect the value of the target cell 318. In a similar manner, for purposes of determining the color value for the target cell 320, the recomposition engine 114 proceeds in a reverse z-order direction, as indicated by reference numeral 370. The processing ends at the layer 303, as the corresponding source cell 374 is opaque or nearly opaque, thereby providing the value for the target cell 320.

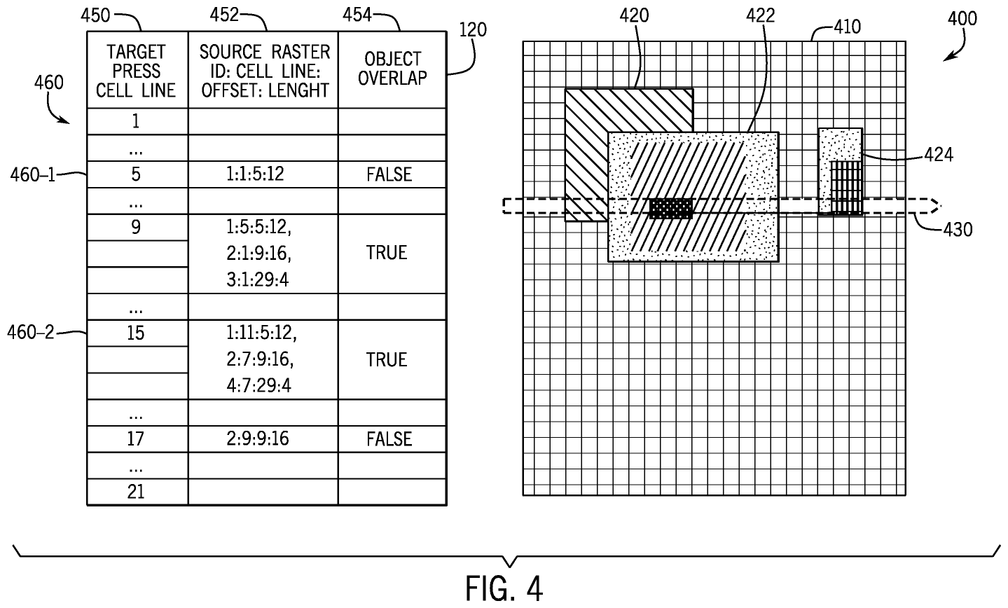

FIG. 4 depicts an illustration 400 of an example object intersection table 120 for an example page 410. For the page 410, a cell is formed by a block of pixels, and the cells that correspond to the page 410 are represented by a grid. The page 410 contains a source object 420, which is overlapped by another object 422. Moreover, page 410 contains a third object 424, which does not overlap either object 420 or 422. In the corresponding object intersection table 120 that is depicted in FIG. 4, rows 460 of the table 120 correspond to the pixel cell lines associated with the page 410.

In accordance with example implementations, each row 460 of the object intersection table 120 identifies the object intersection(s), if any, for an associated cell line. In accordance with example implementations, the object intersection table 120 includes a column 450 that contains a cell line identifier (1, 2, 3, and so forth) identifying the cell line for the associated row 460. Moreover, the object intersection table 120 includes a column 452 that identifies information pertaining to the objects that are contained in the associated cell line.

For example, row 460-2 contains information pertaining to cell line number “15,” which is highlighted and assigned reference numeral 430 on the page 410. For the row 460-2, the column 452 contains three entries: an entry for each object of the cell line. Each entry, in turn, describes an identifier for the object, the cell line on which the object begins, the horizontal cell offset for the object, and the horizontal length of the object. For example, for the first entry in column 452 for the row 460-2, the entry is “1:11:5:12,” which means object number 1 (i.e., object 420) begins on cell line number “11,” begins on cell “5” of the cell line, and has a length of “12” contiguous cells.

As also depicted in FIG. 4, in accordance with some implementations, the object intersection table 120 contains a column 454, which indicates whether the objects of the associated cell line intersect, or overlap. In this manner, in accordance with some implementations, the column 454 contains a Boolean value that is “True” to indicate object overlap and is “False” to indicate that no objects overlap in the associated cell line. For example, for example row 460-1, the object 420 (i.e., object “1”) appears in the associated cell line and no other objects appear in the cell line; and as such, the corresponding Boolean value in column 454 is “False.” However, for example row 460-2, three objects overlap, thereby corresponding to a Boolean value of “True” in the column 454.

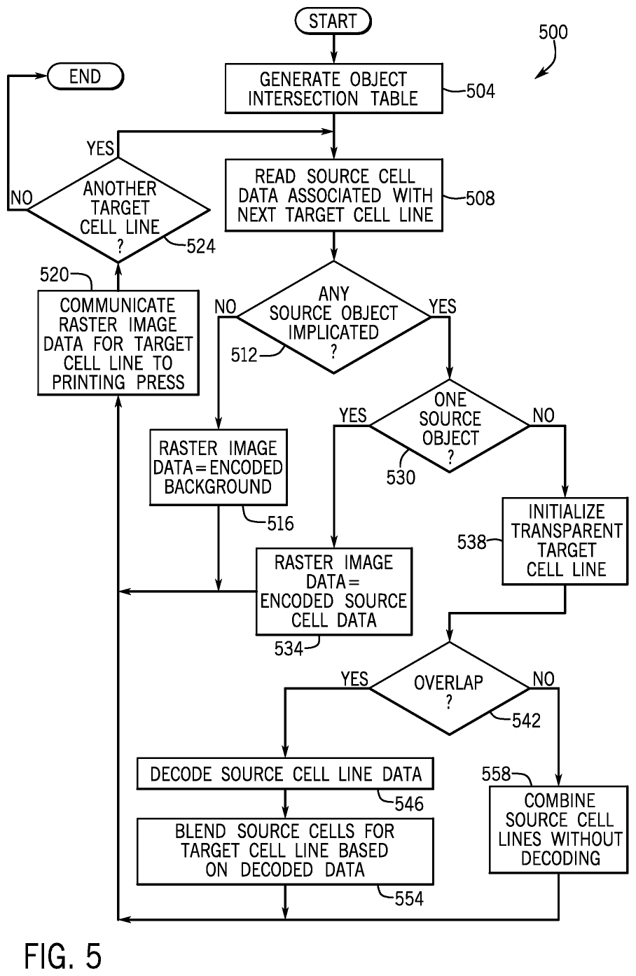

Referring to FIG. 5, in accordance with example implementations, the recomposition engine 114 uses the object intersection table 120 pursuant to a technique 500 for purposes of generating raster image data for a document page. In particular, pursuant to the technique 500, the recomposition engine 114 first generates (block 504) an object intersection table for the page and then reads (block 508) source cell data for the next target cell line to be processed. From this data, the recomposition engine 114 determines (decision block 512) whether any source object is implicated for the target cell line. If not, then, in accordance with example implementations, the recomposition engine 114, pursuant to block 516, sets the raster image data equal to the encoded background data and communicates (block 520) the raster image data for the target cell line to the printing press 160 (FIG. 1). Moreover, if a determination is made (decision block 524) that another target cell line is to be processed, control returns to block 508.

If at least one source object is implicated for the target cell line (per decision block 512), the recomposition engine 114 determines (decision block 530) whether a single source object is implicated for the target cell line; and if so, the recomposition engine 114 sets the raster image data equal to the encoded source cell data, pursuant to block 534, and communicates the raster image data to the printing press pursuant, to block 520.

In accordance with example implementations, if two or more source objects are implicated for the target cell line, then, pursuant to block 538, the recomposition engine 114 initializes a transparent target cell line, pursuant to block 538. If the recomposition engine 114 then determines (decision block 542) that an intersection or overlap between source objects occur for the cell line, the recomposition engine 114 decodes (block 546) the source cell line data (e.g., decodes the run length encoding) and blends (block 554) the source pixel cells for the target cell line based on the decoded data. Otherwise, if multiple objects do not overlap for the target cell line (as determined in decision block 542), the recomposition engine 114 combines (block 558) the source cell lines without decoding to form the raster image data.

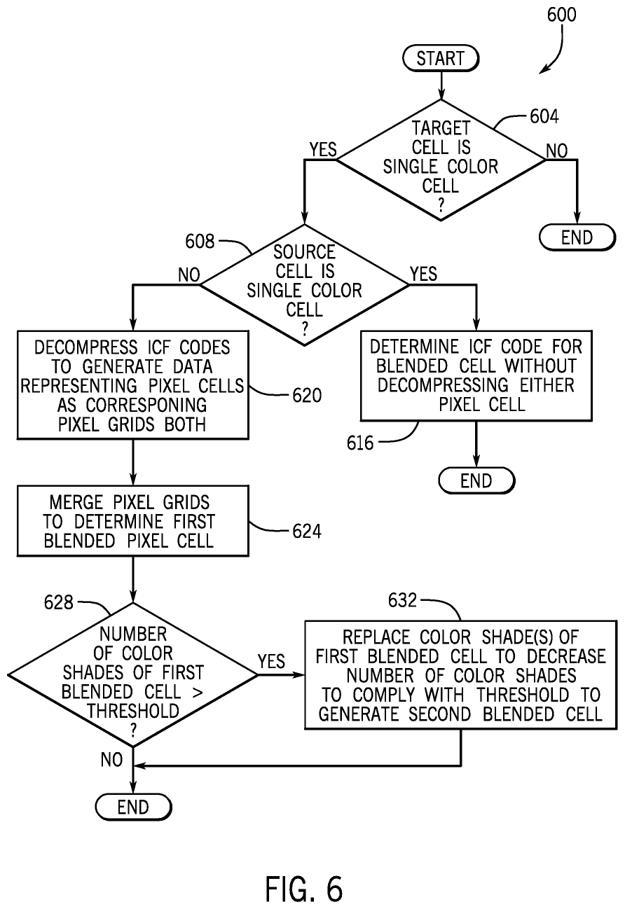

FIG. 6 depicts a technique 600 to blend a target pixel cell and a source pixel cell according to an example implementation. Referring to FIG. 6, the technique 600 includes determining (decision block 604) whether the target cell is an edge cell. If not, in accordance with example implementations, the target cell is a single color cell, which dominates due to the reverse z order blending. In other words, a single color cell, in accordance with example implementations, is opaque, and when a single color cell appears in the target cell line, then no other pixel cell is visible below it. As such, if the target cell is a single color cell (and not an edge cell), the blending terminates.

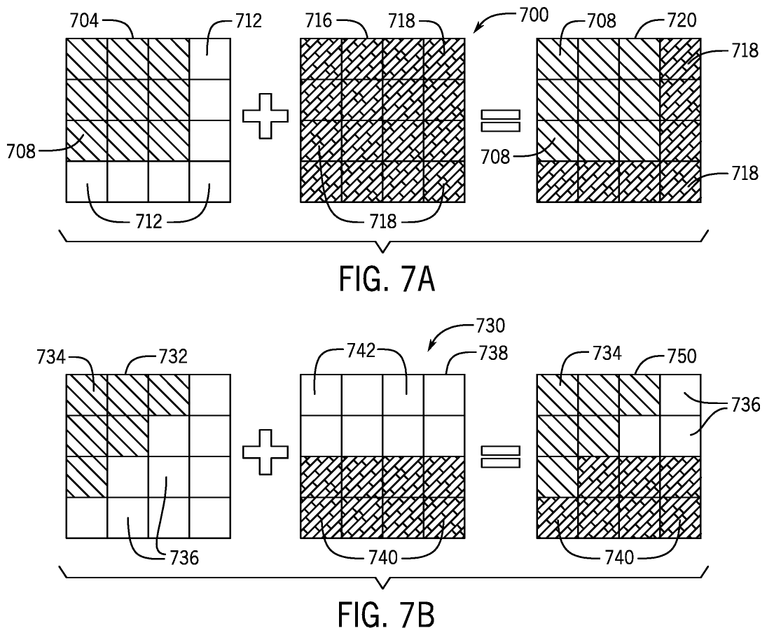

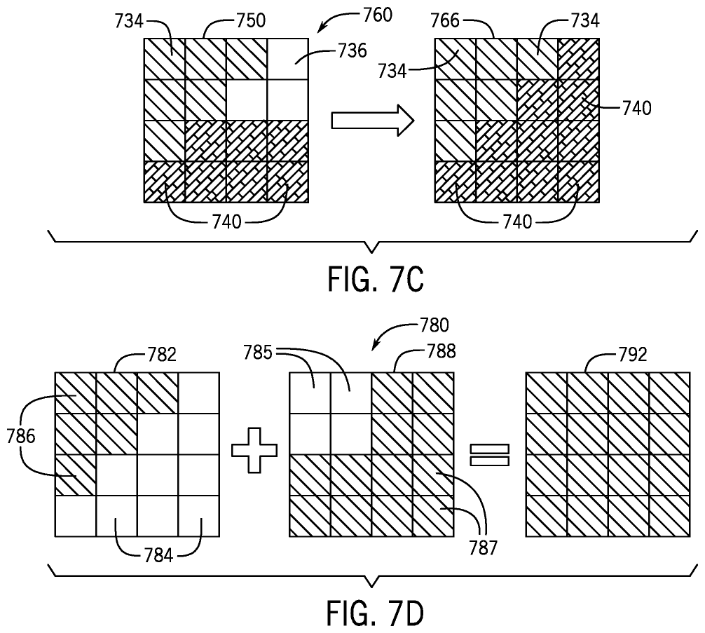

If, however, a determination is made pursuant to decision block 604 that the target cell is an edge cell (i.e., the target cell is not a single color cell), then it is possible that pixels of the source cell will be visible beneath the target cell. The technique 600 includes determining (decision block 608) whether the source cell is a single color cell. If so, then, accordance with example implementations, the ICF code for the blended pixel cell may be derived without decompressing either cell. In this manner, an ICF code for the blended cell may be derived by looking up an ICF code (from a lookup table, for example) that represents transparent pixels of the target cells being replaced with solid color pixel cells of the source pixel cell. This is illustrated in FIG. 7A for an example target pixel cell 704 (an edge cell) being blended with a solid color source pixel cell 716, which contains opaque, color pixels 718. The target pixel cell 704 includes transparent pixels 712, and as such, after the blending, the color pixels 718 of the source pixel 716 are visible, as depicted by blended pixel cell 720. For purposes of deriving the blended cell 720, the technique 600 may include lookup an ICF code from a lookup table, based on the ICF code for the target pixel cell 704, an edge cell, and the ICF code for the single color source cell 716. In other words, in accordance with example implementations, the blending occurs in the ICF compressed domain without decompressing the target 704 or source 716 pixel cells.

Referring to FIG. 6, If, pursuant to decision block 608, a determination is made that the source cell is an edge cell (the “no” prong of decision block 608), then, according to example implementations, the technique 600 includes decompressing (block 620) the ICF codes of the target and source pixel cells to generate data representing the pixel cells as corresponding pixel grids. In other words, the blending is performed “on a canvas” without using the relatively compact ICF codes for the pixel cells. Therefore, pursuant to block 624, the pixel grids are merged on a pixel by pixel basis to determine a blended pixel cell.

As a more specific example FIG. 7B is an illustration 730 in which a target cell 732, an edge cell, is blended with a source cell 738, which is also an edge cell, to produce a blended pixel cell 750. The target pixel cell 732 contains relatively opaque pixels 734 and relatively transparent pixels 736; and the source pixel cell 738 contains relatively transparent pixels 742 and relatively opaque pixels 740. In the blended pixel cell 750, the opaque pixels 734 of the source pixel cell 732 dominant; the opaque pixels 740 of the source pixel cell 738 appear where these pixels 740 are overlapped by the transparent pixels 736 of the target pixel cell 732; and the transparent pixels 736 of the target pixel cell 732 remain where the pixels 736 overlap the transparent pixels 742 of the source pixel cell 738. Thus, as can be seen in FIG. 7B, the blended pixel cell 750 for this example contains three color shades.

In accordance with some implementations, the edge cell may be limited to a predetermined number of color shades. For example, in accordance with some implementations, this number limit may be two. However, as depicted by example blended pixel cell 740 of FIG. 7B, this limit may be exceeded when edge cells are blended pixel by pixel in the uncompressed domain.

Referring to FIG. 6, in accordance with example implementations, the blending may include, pursuant to decision block 628, whether the number of color shades of the blended cell (called the “first blended cell” in block 628) is greater than a threshold (for this example, greater than two). If so, pursuant to block 632 of the technique 600, one or multiple color shades of the first blended cell may be replaced to decrease the number of color shades so that the number of shades complies with the threshold (the number of shades is two or less, for this example).

More specifically, FIG. 7C is an illustration 760 of the reduction of the number of color shades of the blended pixel cell 750 (FIG. 7B) to produce a second blended cell 766 that has two color shades. In accordance with some implementations, the blending may determine distances between the colors and combined colors that are closest together. For the example of FIG. 7C, the first blended cell 760 has three color shades, with, for this example, the pixels 740 having a color shade that is closer in color distance to the pixels 736 than to the pixel 740. In accordance with some implementations, the pixels having the lowest transparency, here the pixels 736, may be replaced with the pixels that are the closest in color distance, here the pixels 740. Other techniques may be used to combine or replace color shades for purposes of reducing the number of color shades of the final blended cell, in accordance with further example implementations.

It is possible for the blending of two pixel cells to produce a single color pixel cell. In this manner, FIG. 7D is an illustration 780 of the blending of a target edge 782 and a source edge cell 788, which results in a single color, blended cell 792. Thus, as depicted in FIG. 7D, the target pixel cell 782 may contain pixels 786 associated with a particular color and transparent pixels 784. The source pixel cell 788 contains single color pixels 787, which have the same color as the single color pixels 786 of the target pixel cell 782; and the source pixel cell 788 contains transparent pixels 785. The single color pixels 786 dominant in the blended pixel cell 792, and for this example, all of the transparent pixels 784 of the target pixel cell 782 are replaced in the blended pixel cell 792 with the solid pixels 787 of the source pixel cell 788.

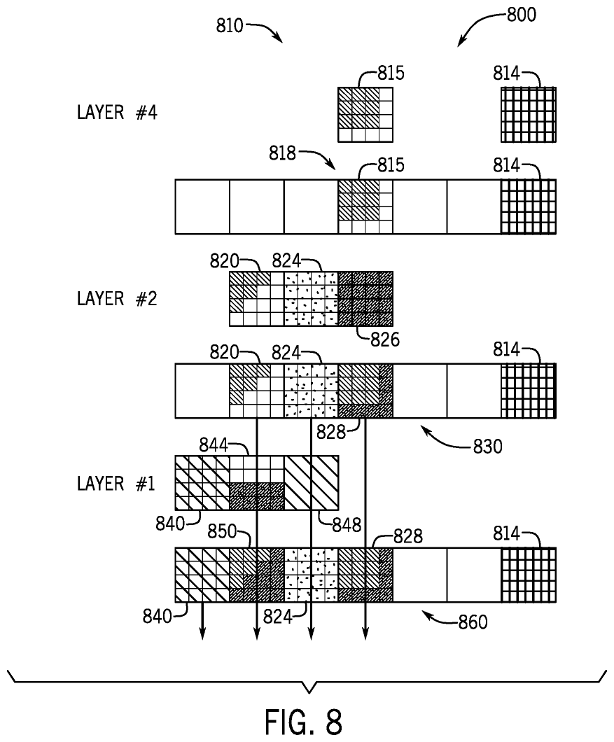

FIG. 8 depicts an illustration 800 of the blending of object source cells to create a target cell line in accordance with example implementations. In this manner, the recomposition engine 114 first initializes a transparent target cell line (i.e., the target cell line in its initial state) and then adds the source pixel cell(s) from an uppermost layer 810 (i.e., layer number 4 for this example). For this example, layer number 4 contains object source pixel cells 814 and 815. The source pixel cell 815 is an edge cell. The source pixel cell 814 is a single color cell, which dominates the corresponding target cell location (nothing appears from below the pixel cell 814). Therefore, no blending occurs for the pixel cell location. Because the initial target cell line is transparent, the source pixel cells 814 and 815 are added to the target cell line to create an intermediate target cell line 818.

For this example, no objects exist in the next lower layer (here, layer number 3). However, the next lower layer (here, layer number 2) contains object source pixel cells 820, 824 and 826: the source pixel cell 820 is an edge cell; and the source pixel cells 824 and 826 are single color pixel cells. Because the target pixel cell line 818 contains transparent target pixel cells that corresponds to the positions of the source pixel cells 820 and 824, the recomposition engine 114 copies the source pixel cells 820 and 824 into to the next intermediate target cell line 814. Because the source pixel cell 826 is a single color pixel cell and the overlapping target pixel cell 815 is an edge cell, the recomposition engine 114 may blend the pixel cells 815 and 826 by looking up the ICF code of the corresponding pixel cell 828 (that appears in the target cell line 814) without decompressing the ICF codes for the pixel cells 815 and 826.

The lowest layer for the sources (layer number 1 for this example) contains three object source pixel cells 840, 844 and 848. The source pixel cell 840 is a single color cell, and the target cell line 830 has a corresponding transparent pixel cell. Therefore, the recomposition engine 114 copies the source pixel cell 840 into the next intermediate target cell line 860. The source pixel cell 848 is dominated by the single color pixel cell 824. Accordingly, the recomposition engine 114 copies the single color pixel cell 824 into the intermediate target cell line 860.

The source pixel cell 844 is an edge cell and is overlapped by the pixel cell 820 of the intermediate target cell line 830. Because the pixel cell 820 is also an edge cell, the recomposition engine 114 decompresses the ICF codes of the pixel cells 820 and 844 and performs the blending pixel by pixel in the uncompressed domain to determine a corresponding blended pixel cell 850 in the intermediate target cell line 860.

In accordance with example implementations, the recomposition engine 114 may blend the target cell line 860 with a background color (i.e., blend the portions of the pixels that are not opaque or nearly opaque with the background color) to form the final target cell line; and then, the recomposition engine 114 may communicate raster image data representing this target cell line, in its final state, to the digital printing press 160.

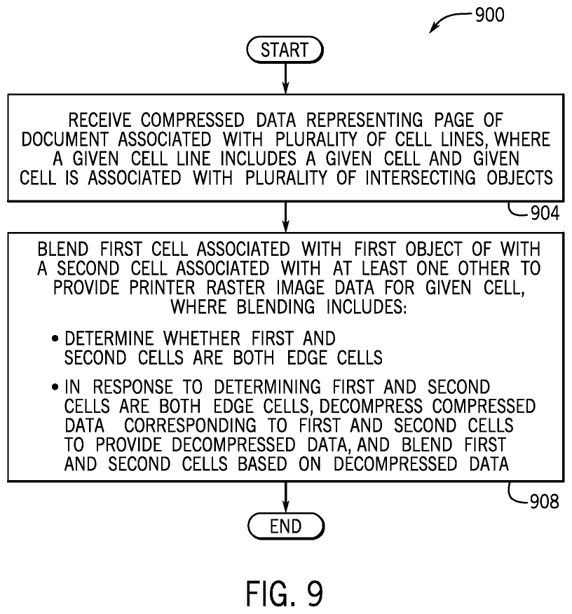

Referring to FIG. 9, thus, in accordance with example implementations, a technique 900 includes receiving (block 904) compressed data that represents a page of a document that is associated with a plurality of cell lines. A given cell line of the plurality of cell lines includes a given cell, and the given cell is associated with a plurality of intersecting objects. The technique 900 includes blending a first cell associated with a first object with a second cell associated with at least one other object to provide printer raster image data for the given cell, pursuant to block 908. The blending may include determining whether the first and second cells are both edge cells; and in response to determining that the first and second cells are both edge cells, decompressing the compressed data corresponding to the first and second cells to provide decompressed data, and blending the first and second cells based on the decompressed data.

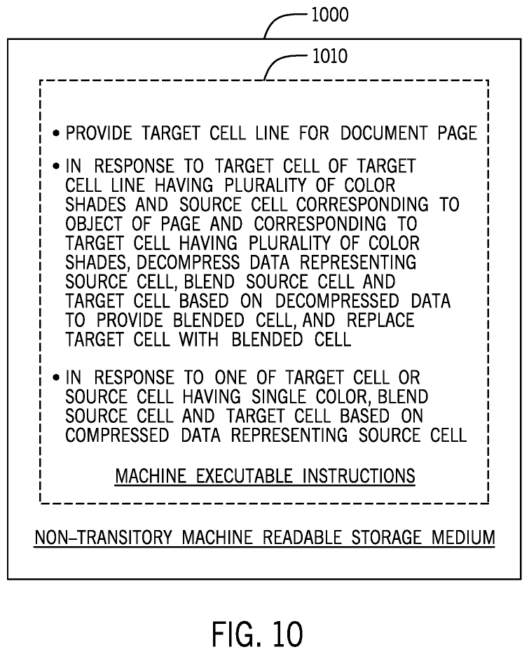

Referring to FIG. 10, in accordance with example implementations, a non-transitory machine readable storage medium 1000 may store machine executable instructions 1010 that, when executed by a machine, cause the machine to provide a target cell line for a document page, where the target cell line includes a target cell; and in response to the target cell having a plurality of color shades and a source cell that corresponds to an object of the page and corresponds to a target cell having a plurality of color shades, decompressed data representing the source cell, blend the source cell and the target cell based on the decompressed data to provide a blended cell, and replace the target cell with the blended cell. The instructions, when executed by the machine, may cause the machine to, in response to one of the target or source cells having a single color, blend the source cell and the target cell based on compressed data representing the source cell.

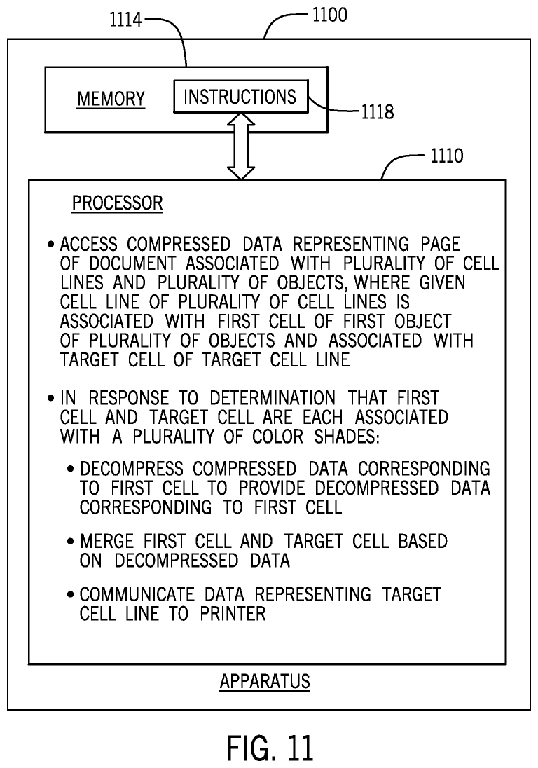

Referring to FIG. 11, in accordance with example implementations, an apparatus 1100 includes a processor 1110 and a memory 1114. The memory 1114 stores instructions 1118 that, when executed by the processor 1110, cause the processor 1110 to provide a target cell line for a document page, where the target cell line includes a target cell and access compressed data representing a page of a document that is associated with a plurality of cell lines and a plurality of objects. A given cell line is associated with a first cell of a first object and associated with the target cell. The instructions 1011, when executed by the processor 1110, cause the processor 1110 to, in response to a determination that the first cell and the target cell are each associated with a plurality of color shades, decompress the compressed data corresponding to the first cell to provide decompressed data corresponding to the first cell, and merge the first cell and the target cell based on the decompressed data. The instructions 1118, when executed by the processor 1110, cause the processor 1110 to communicate data representing the target cell line to a printer.

While the present disclosure has been described with respect to a limited number of implementations, those skilled in the art, having the benefit of this disclosure, will appreciate numerous modifications and variations therefrom. It is intended that the appended claims cover all such modifications and variations

What is claimed is:

1. A method comprising:
receiving compressed data representing a page of a document associated with a plurality of cell lines, wherein a given cell line of the plurality of cell lines comprises a given cell, and the given cell is associated with a plurality of intersecting objects; and
blending a first cell associated with a first object of the plurality of objects with a second cell associated with at least one other object of the plurality of objects to provide printer raster image data for the given cell, wherein the blending comprises:
determining whether the first and second cells are both edge cells; and
in response to determining the first and second cells are both edge cells, decompressing the compressed data corresponding to the first and second cells to provide decompressed data, and blending the first and second cells based on the decompressed data.

2. The method of claim 1, further comprising:
in response to determining that at least one of the first and second cells is not an edge cell, blending the first and second cells without decompressing the compressed data corresponding to the first and second cells.

3. The method of claim 1, wherein:
the first and second cells are both edge cells; and
blending the first and second based on the decompressed data comprises blending the first and second cells based on pixel by pixel comparisons of color shades of the first and second cells.

4. The method of claim 1, wherein:
the second cell is part of a target cell line; and
the blending of the first and second cells further comprises replacing the second cell in the target cell line with a blended cell formed from the first and second cells.

5. The method of claim 4, further comprising:
storing raster data representing the target cell line in a memory;
communicating the raster data representing the target cell line to a printer; and
reusing the memory to generate raster data representing another target cell line of the document page.

6. The method of claim 1, wherein:
the first cell comprises an edge cell comprising a transparent portion;
the second cell comprises a homogenous color cell associated with a given color;
blending the first and second source cells comprises determining a code representing the first source cell with the transparent portion replaced with the given color.

7. The method of claim 1, further comprising:
creating a target cell line for the given cell line, wherein the blending comprises determining data representing a first cell of the target cell line based on the first and second cells.

8. An article comprising a non-transitory machine readable storage medium to store instructions that, when executed by a machine, cause the machine to:
provide a target cell line for a document page, the target cell line comprising a target cell;
in response to the target cell having a plurality of color shades and a source cell corresponding to an object of the page and corresponding to the target cell having a plurality of color shades, decompress data representing the source cell, blend the source cell and the target cell based on the decompressed data to provide a blended cell, and replace the target cell with the blended cell; and
in response to one of the target cell or the source cell having a single color, blend the source cell and the target cell based on compressed data representing the source cell.

9. The article of claim 8, wherein the storage medium to store instructions that, when executed by the machine, causes the machine to:
store raster data representing the target cell line in a memory of the machine;
communicate the raster data representing the target cell line to a printer; and
reuse the memory to generate raster data representing another target cell line of the document page.

10. The article of claim 8, wherein:
the source cell has a plurality of color shades;
the target cell has a plurality of color shades; and
the storage medium to store instructions that, when executed by the machine, causes the machine to:
determine a first blended cell, wherein the first blended cell has a number of colors; and
process the first blended cell to provide a second blended cell, wherein the second blended cell has a number of colors less than the number of colors of the first blended cell.

11. The article of claim 10, wherein:
the first blended cell has a first color, a second color and a third color; and
the storage medium to store instructions that, when executed by the machine, causes the machine to:
determine a first distance between the first color and the second color;
determine a second distance between the first color and the third color;
compare the first and second distances; and
replace the first color with either the second color or the third color based on a result of the comparison.

12. An apparatus comprising:
a processor; and
a memory to store instructions that, when executed by the processor, cause the processor to:
access compressed data representing a page of a document associated with a plurality of cell lines and a plurality of objects, wherein a given cell line of the plurality of cell lines is associated with a first cell of a first object of the plurality of objects and associated with a target cell of a target cell line;
in response to a determination that the first cell and the target cell are each associated with a plurality of color shades:
decompress the compressed data corresponding to the first cell to provide decompressed data corresponding to the first cell;
merge the first cell and the target cell based on the decompressed data; and
communicate data representing the target cell line to a printer.

13. The apparatus of claim 12, wherein the compressed data comprises data representing the first cell in an Indigio Compressed Format (ICF).

14. The apparatus of claim 12, wherein:
the first and second cells are both edge cells; and
the processor merges the first cell and the target cell based on pixel by pixel comparisons of color shades of the first cell and the target cell.

15. The apparatus of claim 12, wherein:
the processor, in response to a determination that one of the first cell or the target cell is not associated with a plurality of color shades, merges the first cell and the target cell to provide compressed data representing a merged cell without decompressing the compressed data.
